(19) United States
(12) Patent Application Publication
(10) Pub. No.: US 2016/0082635 A1
(43) Pub. Date: Mar. 24, 2016

(54) METHOD AND APPARATUS FOR PRODUCING MOLDED ARTICLE OF FIBER-REINFORCED PLASTIC

(71) Applicant: HONDA MOTOR CO., LTD., Tokyo (JP)

(72) Inventors: Masatoshi Kobayashi, Wako-shi (JP); Koji Dan, Wako-shi (JP)

(21) Appl. No.: 14/837,217

(22) Filed: Aug. 27, 2015

(30) Foreign Application Priority Data
Sep. 18, 2014 (JP) 2014-189924

(51) Int. Cl. B29C 45/34; B29C 45/00

(52) U.S. Cl. CPC B29C 45/34; B29C 45/0005; B29L 2031/00

(57) ABSTRACT

A lower mold and an upper mold are combined to form an enclosed space containing a production cavity and a sealed room. A base fiber material is placed in the production cavity. The production cavity has a first space and a second space. After a gas in the enclosed space has been discharged, a first predetermined amount of a liquid resin is supplied to the first space. After supply of the liquid resin is stopped (or while the liquid resin is continuously supplied), the upper mold is lowered relatively further toward the lower mold, whereby the volume of the production cavity becomes reduced. Preferably, a second predetermined amount of the liquid resin is supplied to the first space having a large volume, whereupon the supplied liquid resin flows from the first space into the second space having a small volume.

### CROSS-REFERENCE TO RELATED APPLICATION

This application is based upon and claims the benefit of priority from Japanese Patent Application No. 2014-189924 filed on Sep. 18, 2014, the contents of which are incorporated herein by reference.

### BACKGROUND OF THE INVENTION

1. Field of the Invention

The present invention relates to a method and an apparatus for impregnating a base fiber material with a liquid resin to produce a molded article of a fiber-reinforced plastic.

2. Description of the Related Art

Fiber-reinforced plastics, which are composites made of base fibers and resins, have been known as lightweight high-strength materials. Molded articles made from such fiber-reinforced plastics have recently been used in components for car bodies and airplanes.

Molded articles of fiber-reinforced plastics (hereinafter referred to as molded FRP articles) can be produced, for example, by an RTM (Resin Transfer Molding) method. In the RTM method, a base fiber material is placed in a mold cavity, the mold is closed, gas in the cavity is discharged, and then a liquid resin is supplied to the cavity.

In certain cases, a molded FRP article is required to have a large thickness in excess of 10 mm, or a relatively high fiber content of 50% or more by volume. In short-cycle-time production (high-cycle molding) of such molded FRP articles using the RTM method, it is necessary to use a liquid resin that can be hardened and can exhibit an increased viscosity in a short hardening time. In this case, the base fiber material exhibits a high resistance to flow of the liquid resin. Therefore, the liquid resin may be spread insufficiently over the base fiber material, so that the base fiber material becomes insufficiently impregnated with the resin, thereby generating an unimpregnated area. A molded FRP article with such an unimpregnated area has insufficient strength and cannot be used as a satisfactory product.

As is clear from the above, in a high-cycle RTM method, disadvantageously, it is difficult to produce a molded FRP article having a large thickness or a high fiber content with high yield.

For the purpose of approximately uniformly spreading an appropriate amount of a liquid resin in a cavity, in the technique proposed in Japanese Laid-Open Patent Publication No. 2011-000847, a base fiber material is placed in a cavity between lower and upper molds that are arranged at a predetermined distance, a liquid resin is injected into the cavity while maintaining the molds in an open state, the molds are moved closer to each other while discharging the liquid resin from the cavity, discharging of the liquid resin is stopped, and the liquid resin is hardened while maintaining the molds in a closed state.

For the same purpose, in the technique proposed in International Patent Publication No. 2011/043253, a base fiber material is placed in a cavity between lower and upper molds that are arranged at a predetermined distance, a liquid resin is injected into the cavity while maintaining the molds in an open state, the base fiber material is impregnated with the liquid resin, the molds are closed, and an excess portion of the liquid resin, which is injected and introduced into the base fiber material, is removed by suction.

### SUMMARY OF THE INVENTION

In the techniques described in Japanese Laid-Open Patent Publication No. 2011-000847 and International Patent Publication No. 2011/043253, liquid resin is injected into the cavity when the lower and upper molds are in an open state at a predetermined distance (i.e., an incompletely closed state), whereby resistance to flow of the liquid resin is lowered. However, for example, in the case that a depression and a protrusion have a large height difference in the cavity, the liquid resin cannot be readily transferred from the depression toward the protrusion. Furthermore, in the case that a portion having a significantly small cross-sectional area (a narrow portion) is formed in a flow path of the liquid resin, the liquid resin cannot readily be transferred to the downstream side of the narrow portion without application of a sufficient pressure. Thus, in the known techniques, an unimpregnated area is unavoidably formed in some cases.

Particularly, in production of a large molded article, a slight difference may be generated in the distance between the base fiber material and the upper mold due to a thickness distribution of the base fiber material and the processing accuracy distribution of the mold, etc. A narrow portion having a slightly reduced cross-sectional area may be formed in a position corresponding to the distance difference in the liquid resin flow path. Thus, the liquid resin is not sufficiently transferred through such a narrow portion, and an unimpregnated area is unavoidably formed in some cases.

A general object of the present invention is to provide a molded article of a fiber-reinforced plastic, in which a liquid resin is spread sufficiently even within an end (edge) portion of a base fiber material.

A principal object of the present invention is to provide a molding method for producing a molded article of a fiber-reinforced plastic without formation of an unimpregnated area.

Another object of the present invention is to provide a molding apparatus for enabling the molding method to be performed.

According to an aspect of the present invention, there is provided a molding method for impregnating a base fiber material placed in a production cavity defined between a lower mold and an upper mold, with a liquid resin supplied to the production cavity, in order to produce a molded article of a fiber-reinforced plastic.

In the above-described method, a first sealing member and a second sealing member are disposed respectively on the lower mold and the upper mold, or both the first sealing member and the second sealing member are disposed on the lower mold or the upper mold, and at least one of the lower mold and the upper mold has an exhaust passage.

The method comprises:

a first step of, when the upper mold is moved relatively toward the lower mold, using the first sealing member to form an enclosed space containing the production cavity between the lower mold and the upper mold;

a second step of, after formation of the enclosed space, discharging a gas in the enclosed space from the exhaust passage;

a third step of, when the upper mold is moved relatively further toward the lower mold, using the second sealing member to divide the enclosed space into the production cavity and a sealed room, wherein the sealed room is formed between the first sealing member and the second sealing member and communicates with the exhaust passage, and thereafter supplying a first predetermined amount of the liquid resin to the production cavity;

a fourth step of, when the upper mold is moved relatively further toward the lower mold, reducing the volume of the production cavity;

a fifth step of, at the same time or after a reduction in volume of the production cavity, supplying a second predetermined amount of the liquid resin to the production cavity and allowing the liquid resin to flow; and

a sixth step of hardening the liquid resin, with which the base fiber material has been impregnated, to thereby prepare the molded article, and thereafter releasing the molded article from the lower mold and the upper mold.

According to another aspect of the present invention, there is provided a molding apparatus comprising a lower mold, an upper mold, an exhaust unit, and an injector, configured to impregnate a base fiber material placed in a production cavity defined between the lower mold and the upper mold, with a liquid resin supplied to the production cavity, in order to produce a molded article of a fiber-reinforced plastic.

In the molding apparatus, a first sealing member and a second sealing member are disposed respectively on the lower mold and the upper mold, or both the first sealing member and the second sealing member are disposed on the lower mold or the upper mold, and at least one of the lower mold and the upper mold has an exhaust passage.

When the upper mold is moved relatively toward the lower mold, the first sealing member is used to form an enclosed space containing the production cavity between the lower mold and the upper mold.

After formation of the enclosed space and when the upper mold is moved relatively further toward the lower mold, the second sealing member is used to divide the enclosed space into the production cavity and a sealed room. The sealed room is formed between the first sealing member and the second sealing member and communicates with the exhaust passage.

Prior to formation of the sealed room, a gas in the enclosed space is discharged from the exhaust passage by the exhaust unit.

The liquid resin is supplied through the lower mold or the upper mold to the production cavity by the injector.

After a first predetermined amount of the liquid resin has been supplied to the production cavity and when the upper mold is moved relatively further toward the lower mold and a volume of the production cavity is reduced. At the same time or after a reduction in volume of the production cavity, a second predetermined amount of the liquid resin is supplied to the production cavity by the injector.

In the present invention, after the first predetermined amount of the liquid resin has been supplied to the production cavity, the upper mold is moved relatively further toward the lower mold in order to reduce the volume of the production cavity, and the second predetermined amount of the liquid resin is supplied to the production cavity and is allowed to flow into the production cavity. Therefore, even in the case that the production cavity has a large height difference or a narrow portion, the liquid resin can readily be introduced or spread to the end of the production cavity. Thus, the molding method can be used for producing a large molded article without the formation of an unimpregnated area therein. In addition, the first and second predetermined amounts may be the same or different amounts.

The first and second predetermined amounts of the liquid resin are supplied to the production cavity under a negative pressure, and the upper mold is pressed against the liquid resin. Therefore, the liquid resin can be spread readily over the entire base fiber material. Thus, a molded FRP article having a large thickness or a high fiber volume content can easily be produced.

Consequently, the present invention exhibits advantageous effects, even in the case that the production cavity has a complicated shape, or even if the liquid resin cannot be spread over the base fiber material surface by supplying the resin only once, and even if an unimpregnated area is generated in the liquid resin.

In the case that the liquid resin is supplied excessively above the base fiber material, the liquid resin is blocked by the second sealing member. Therefore, the liquid resin can be prevented from leaking outside of the production cavity. Thus, lack of liquid resin caused by leakage of the liquid resin can be prevented, and the occurrence of an unimpregnated area in the molded FRP article can be prevented. Consequently, a molded FRP article of satisfactory strength can be produced with high yield.

Furthermore, since the liquid resin is blocked by the second sealing member, the liquid resin can be prevented from being drawn into the sealed room and the exhaust passage that communicates with the sealed room. Thus, a reduction in the inspiratory force in a subsequent molding process can be prevented.

In addition, even if a valve is formed in the exhaust passage, it is not necessary to take apart and clean the valve or to replace the valve. For these reasons, a greater number of moldings can be performed per unit time, so that molded FRP articles can be produced with improved efficiency.

Thus, in the present invention, the resin can be spread satisfactorily up to the edge of the base fiber material, and molded FRP articles having a complicated three-dimensional shape, a large thickness, or a high fiber volume content can be produced efficiently with satisfactory strength and high yield.

After the first predetermined amount of the liquid resin has been supplied, and until the second predetermined amount of the liquid resin starts to be supplied to the production cavity, the upper mold may be moved relatively toward the lower mold in a continuous manner. In other words, the third and fourth steps may be carried out successively while the upper mold is moved relatively toward the lower mold.

After the first predetermined amount of the liquid resin has been supplied and until the second predetermined amount of the liquid resin starts to be supplied, supply of the liquid resin may be stopped. Alternatively, a smaller amount of the liquid resin may be supplied continuously to the production cavity. The smaller amount is smaller than the first and second predetermined amounts.

In the fifth step, the second predetermined amount of the liquid resin may be supplied to the production cavity at the same time or after termination of closing of the molds. Stopping of supply of the liquid resin, the reduction in volume of the production cavity, and resupply of the liquid resin may be carried out repeatedly.

The production cavity may contain a first space and a second space, and the second space may be connected to the first space and have a volume smaller than that of the first space. In this case, after the enclosed space has been divided into the production cavity and the sealed room using the second sealing member, closing of the molds is temporarily stopped, and then the liquid resin is supplied to the first space. In addition, at the same time or after the reduction in volume of the production cavity, the second predetermined amount of the liquid resin is supplied to the first space and is allowed to flow into the second space.

Thus, in this case, the second predetermined amount of the liquid resin is supplied to the first space, and thereafter, the liquid resin flows into the second space having a reduced volume. When the second predetermined amount of the liquid resin is supplied, the first space is already filled with liquid resin. Therefore, the supplied liquid resin is readily transferred toward the second space. Consequently, the liquid resin can be readily introduced or spread to the end of the second space. In a typical example, the first space is in the shape of a vertically downward extending depression, whereas the second space is in the shape of a vertically upward extending protrusion.

For example, the lower mold has a flat wall and a rising wall that extends therefrom, the upper mold has an opposite flat wall facing the flat wall and an opposite rising wall that extends therefrom and faces toward the rising wall, and the first space contains a space that is formed by the flat wall, the rising wall, the opposite flat wall, and the opposite rising wall. In this case, the normal distance between the rising wall and the opposite rising wall is smaller than the normal distance between the flat wall and the opposite flat wall. Thus, a narrow portion having a small cross-sectional area is formed between the rising wall and the opposite rising wall.

In this case, the liquid resin flows from an upstream clearance between the flat wall and the opposite flat wall toward a downstream clearance between the rising wall and the opposite rising wall, and further flows into the second space. Thus, the second space is formed on a downstream side of the downstream clearance between the rising wall and the opposite rising wall.

In the present invention, as described above, the volume of the production cavity is reduced, and the second predetermined amount of the liquid resin is supplied to the production cavity. Therefore, the supplied liquid resin possesses a sufficient pressure. In addition, due to the small cross-sectional area in the narrow portion, the pressure that acts on the liquid resin is increased. Therefore, the liquid resin can readily be introduced into the second space.

Consequently, in the molding apparatus having the above-described structure, the liquid resin can be spread up to the end of the production cavity. Thus, the resin can be satisfactorily spread up to the edge of the base fiber material, and molded FRP articles having a complicated three-dimensional shape, a large thickness, or a high fiber volume content can easily be produced with high yield.

In the fifth step, the second predetermined amount of the liquid resin may be supplied to the first space after closing of the molds has been temporarily stopped. Alternatively, supply of the liquid resin may be started during closing of the molds without temporarily stopping closing of the molds. Alternatively, supply of the second predetermined amount of the liquid resin to the first space (the fifth step) may be started at the same time or after termination of closing of the molds.

As described above, after the first predetermined amount of the liquid resin has been supplied to the first space and until the second predetermined amount of the liquid resin starts to be supplied to the first space, supply of the liquid resin may be stopped. Alternatively, a smaller amount of the liquid resin may be supplied continuously, the smaller amount being smaller than the first and second predetermined amounts. Stopping of supply of the liquid resin to the first space, the reduction in volume of the production cavity, and resupply of the liquid resin to the first space may be carried out repeatedly.

The above structure preferably further comprises a sealed room opening unit, which is capable of opening the sealed room to atmosphere by way of the exhaust passage. After the production cavity and the sealed room have been formed by the second sealing member, the sealed room may be opened to atmosphere (may be placed under atmospheric pressure), and thereafter, supply of the liquid resin may be carried out. In this case, if the liquid resin cannot be blocked sufficiently due to a defect in the second sealing member, the liquid resin is pressed by atmospheric air, due to the fact that the production cavity is kept under a negative pressure.

Thus, in this case, the liquid resin can further be effectively prevented from being drawn into the sealed room and the exhaust passage.

The sealed room opening unit preferably contains a three-way valve.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic vertical cross-sectional view of a principal part of a fiber-reinforced plastic molding apparatus in an open state according to an embodiment of the present invention;

FIG. 2 is a schematic vertical cross-sectional view of an enclosed space, which is formed between a lower mold and an upper mold during a process of changing the molds from the open state shown in FIG. 1 to a closed state;

FIG. 3 is a schematic vertical cross-sectional view of a sealed room and a production cavity, which are formed by dividing the enclosed space during the process of changing the molds from the state shown in FIG. 2 to the closed state;

FIG. 4 is a schematic vertical cross-sectional view of a liquid resin that is supplied to the production cavity;

FIG. 5 is a schematic vertical cross-sectional view of the liquid resin as the liquid resin is spread along a base fiber material in the closed state;

FIG. 6 is a schematic vertical cross-sectional view of a molded FRP article prepared by impregnating the base fiber material with the liquid resin; and

FIG. 7 is a schematic vertical cross-sectional view of the molded FRP article after having been released from the opened molds.

### DESCRIPTION OF THE PREFERRED EMBODIMENTS

A preferred embodiment of the molding method of the present invention for producing a molded article of a fiber-reinforced plastic (a molded FRP article) using the molding apparatus of the present invention will be described in detail below with reference to the accompanying drawings.

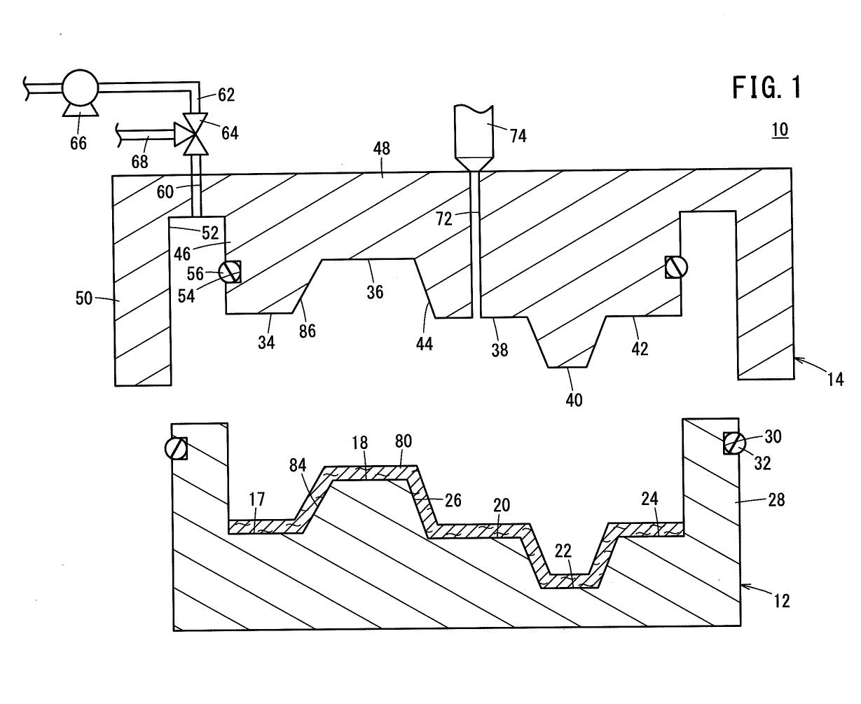

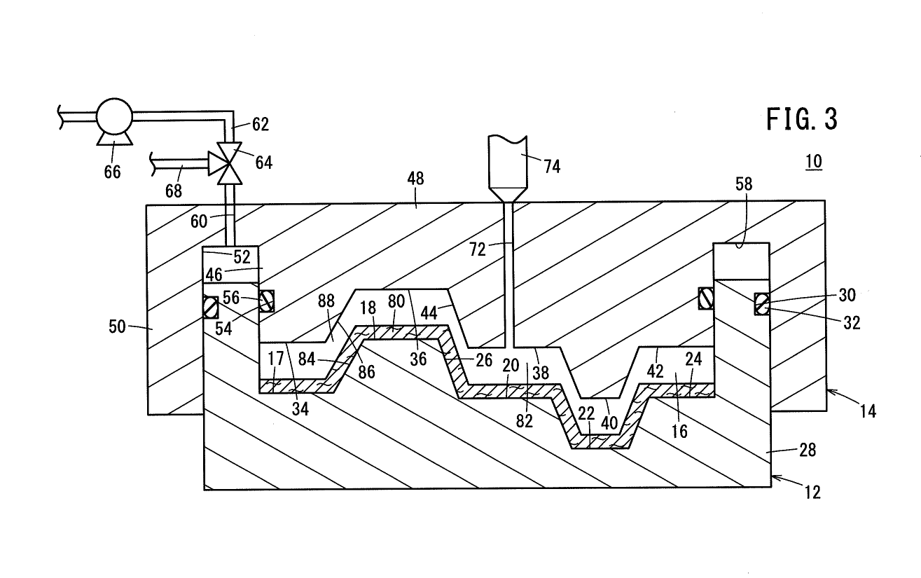

FIG. 1 is a schematic vertical cross-sectional view of a principal part of a fiber-reinforced plastic molding apparatus 10 (hereinafter referred to simply as a molding apparatus 10) according to the present embodiment. The molding apparatus 10 contains a lower mold 12 and an upper mold 14 as a molding tool. A production cavity 16 is formed between the lower mold 12 and the upper mold 14 (see FIGS. 3 to 6). In FIG. 1, the molding apparatus 10 is shown in an open state.

The lower mold 12 is a stationary mold, which is fixed in a given position. A first flat wall 17, a first protrusion 18, a second flat wall 20, a first depression 22, and a third flat wall 24 are arranged on a cavity forming surface of the lower mold 12 in this order from the left to the right of FIG. 1. The first protrusion 18 extends vertically upward from the first flat wall 17 and the second flat wall 20, and the first depression 22 extends vertically downward from the second flat wall 20 and the third flat wall 24.

In this structure, between the second flat wall 20 and a top surface of the first protrusion 18, a first inclined wall 26 (rising wall) extends from the second flat wall 20 toward the top surface of the first protrusion 18.

A protruding portion 28, which extends toward the upper mold 14, is formed on an edge of the upper surface of the lower mold 12. A first groove 30 is formed around the outer surface of the protruding portion 28. A first sealing member 32 is inserted into the first groove 30. A significant portion of the first sealing member 32 protrudes from the first groove 30.

On the other hand, the upper mold 14 is a movable mold, which can be lowered and raised (moved closer to and farther away from the lower mold 12) by an elevating mechanism (not shown). A fourth flat wall 34 that faces toward the first flat wall 17, a second depression 36 into which the first protrusion 18 is inserted, a fifth flat wall 38 that faces toward the second flat wall 20 (an opposite flat wall), a second protrusion 40 inserted into the first depression 22, and a sixth flat wall 42 that faces toward the third flat wall 24 are arranged on the cavity forming surface of the upper mold 14 in this order from the left to the right of FIG. 1. In this structure, a second inclined wall 44 (opposite rising wall) that faces toward the first inclined wall 26 (rising wall) is interposed between the fifth flat wall 38 and a ceiling surface of the second depression 36.

When the upper mold 14 having the cavity forming surface is moved toward the lower mold 12, closing of the molds is carried out to form the production cavity 16 (see FIGS. 3 to 6).

The upper mold 14 further includes a column 46 and a base 48. The cavity forming surface is connected to the base 48 by way of the column 46.

A surrounding wall 50, which extends toward the lower mold 12, is formed on an edge of the lower surface of the base 48. In the closed state, the outer surface of the protruding portion 28 is surrounded by the surrounding wall 50. Therefore, a relatively depressed insertion portion 52 is formed between the column 46 and the surrounding wall 50. Thus, the insertion portion 52 is formed by a side surface of the column 46, a lower surface of the base 48, and an inner surface of the surrounding wall 50.

A second groove 54 is formed around the side surface of the column 46 (i.e., on the insertion portion 52). A second sealing member 56 is inserted into the second groove 54. A significant portion of the second sealing member 56 protrudes from the second groove 54, in the same manner as the first sealing member 32.

As will be described later, the protruding portion 28 is inserted into the insertion portion 52. At this time, the first sealing member 32 is brought into contact with the inner surface of the surrounding wall 50, and the second sealing member 56 is brought into contact with the inner surface of the protruding portion 28 (see FIG. 3). As a result, a room, which is separated from the production cavity 16 (hereinafter referred to as a sealed room 58), is formed between the first sealing member 32 and the second sealing member 56.

The base 48 includes an exhaust passage 60 that communicates with the sealed room 58. The exhaust passage 60 is connected with an exhaust tube 62. A three-way valve 64 and a pump (exhaust unit) 66 are arranged on the exhaust tube 62 in this order from the exhaust passage 60.

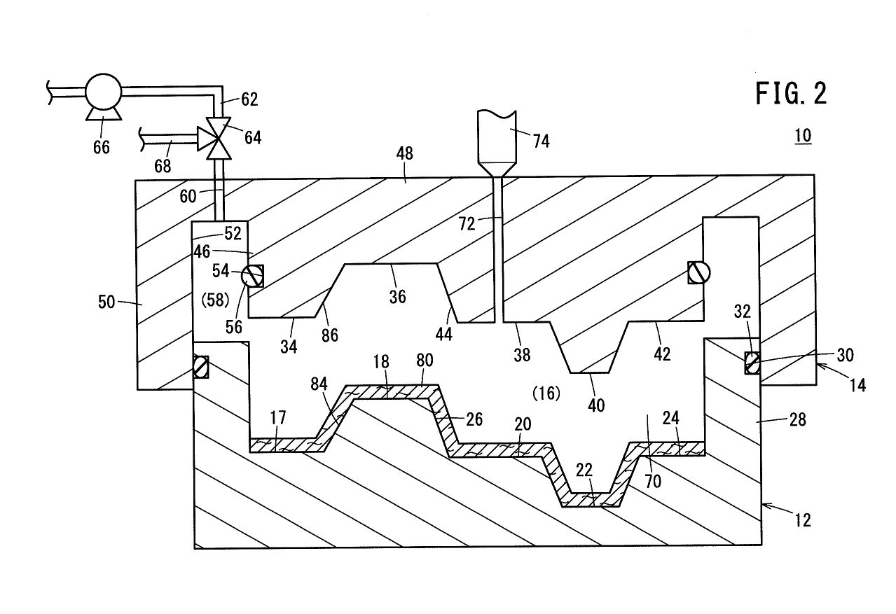

The three-way valve 64 also is connected with an open tube 68 that is opened to atmosphere. Thus, the three-way valve 64 acts to switch between a flow path that communicates with the pump 66, and a flow path that communicates with atmosphere. When the flow path that communicates with the pump 66 is selected, a gas in an enclosed space 70, which will be described later, is discharged by the pump 66 (see FIG. 2). On the other hand, when the flow path that communicates with atmosphere is selected, the sealed room 58 is opened to atmosphere. Thus, the three-way valve 64 acts as a sealed room opening unit. Further, one of the three ports of the three-way valve 64 may be opened to atmosphere without using the open tube 68.

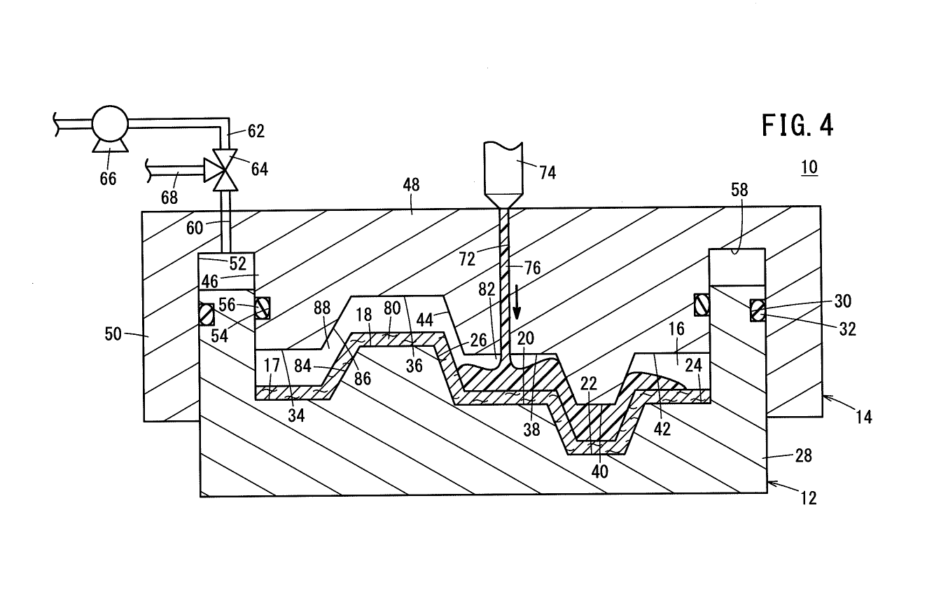

The upper mold 14 has a runner 72 that extends from the base 48, through the column 46, and to the fifth flat wall 38. The runner 72 functions as a supply channel for supplying a liquid resin 76 from an injector 74 to the production cavity 16 (see FIG. 4).

The molding apparatus 10 according to the present embodiment is constructed basically as described above. Operations and advantages of the molding apparatus 10 will be described below, in relation to an FRP molding method according to the present embodiment.

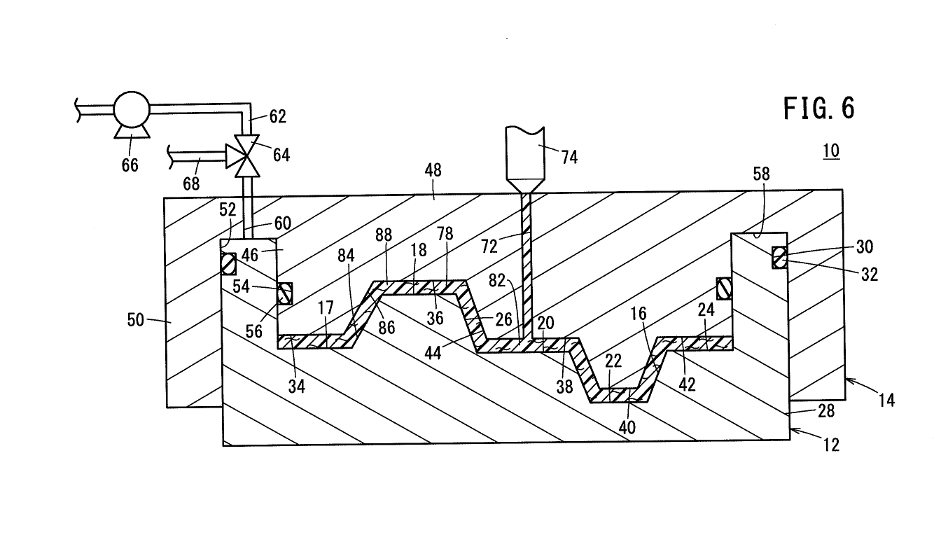

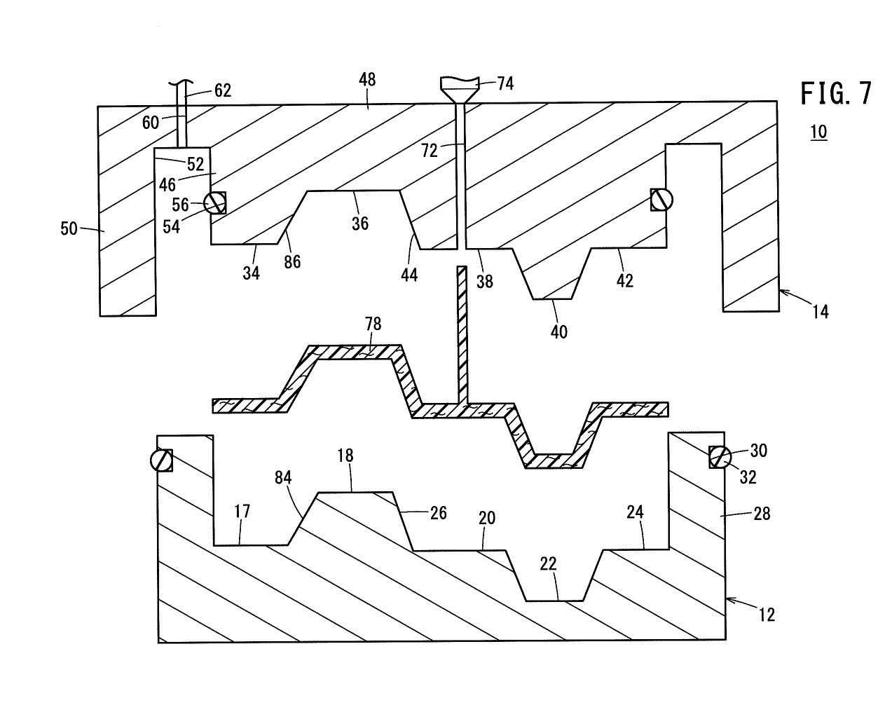

As shown in FIG. 1, while the molding apparatus 10 is maintained in an open state, a base fiber material 80 for forming a molded FRP article 78 (see FIGS. 6 and 7) is placed on the cavity forming surface of the lower mold 12. During this step, the lower mold 12 and the upper mold 14 are separated from each other, and a space, which is opened to atmosphere, is formed between the lower mold 12 and the upper mold 14. Further, during this step, the three-way valve 64 is closed.

Next, the elevating mechanism is driven to initiate a first step of the molding method, whereby the upper mold 14 is lowered toward the lower mold 12. During lowering thereof, the inner surface of the surrounding wall 50 in the upper mold 14 faces toward the outer surface of the protruding portion 28 in the lower mold 12. When the inner surface of the surrounding wall 50 comes into contact with the first sealing member 32, a gap between the protruding portion 28 and the surrounding wall 50 is sealed by the first sealing member 32. As a result, as shown in FIG. 2, the enclosed space 70, which is shielded from atmosphere, is formed between the lower mold 12 and the upper mold 14. As can be clearly understood from FIGS. 2 to 4, the enclosed space 70 includes the production cavity 16 and the sealed room 58 in a connected state.

After the enclosed space 70 has been formed in the foregoing manner, a second step of the molding method is started. The pump 66 is driven, and the three-way valve 64 is operated in order to select the flow path that communicates with the pump 66. Thus, the exhaust tube 62 communicates with the enclosed space 70, so that air in the enclosed space 70 is discharged by the pump 66. Consequently, the inner pressure of the enclosed space 70 is reduced to a negative pressure of about 50 to 100 kPa.

The upper mold 14 is lowered continuously while the air in the enclosed space 70 is discharged. Therefore, as shown in FIG. 3, the first protrusion 18 is introduced into the second depression 36, and the second protrusion 40 is introduced into the first depression 22. In addition, the protruding portion 28 moves closer toward the insertion portion 52, so that the inner surface of the protruding portion 28 faces the side surface of the column 46. Thus, the molding apparatus 10 is brought closer in proximity to the closed state.

When the inner surface of the protruding portion 28 comes into contact with the second sealing member 56, a gap between the protruding portion 28 and the column 46 is sealed by the second sealing member 56. Meanwhile, the gap between the protruding portion 28 and the surrounding wall 50 is maintained in a sealed state by the first sealing member 32. Therefore, the sealed room 58 is formed between the first sealing member 32 and the second sealing member 56. As clearly shown in FIG. 3, the sealed room 58 is separated from the production cavity 16 by the second sealing member 56. In other words, the enclosed space 70 is divided respectively into the sealed room 58 and the production cavity 16, and the sealed room 58 and the production cavity 16 are separated from each other.

In the right side of the production cavity 16, a first space 82 is formed by the first inclined wall 26 (rising wall) that extends from the second flat wall 20 toward the top surface of the first protrusion 18, the second flat wall 20, the first depression 22, the third flat wall 24, the second inclined wall 44 (opposite rising wall) that extends from the fifth flat wall 38 toward the ceiling surface of the second depression 36, the fifth flat wall 38, the second protrusion 40, and the sixth flat wall 42. In the left side of the production cavity 16, a second space 88 is formed by the first flat wall 17, an inclined wall 84 that extends from the first flat wall 17 toward the top surface of the first protrusion 18, the fourth flat wall 34, an inclined wall 86 that extends from the fourth flat wall 34 toward the ceiling surface of the second depression 36, and the ceiling surface of the second depression 36. The second space 88 is connected to a clearance formed in the first space 82 between the first inclined wall 26 and the second inclined wall 44.

The first inclined wall 26 and the second inclined wall 44 are arranged in facing relation to each other. The clearance between the inclined walls 26 and 44 is narrower than a clearance formed between the top surface of the first protrusion 18 and the ceiling surface of the second depression 36, and a clearance formed between the second flat wall 20 and the fifth flat wall 38. In other words, the clearance between the inclined walls 26 and 44 makes up a narrow portion, which has a cross-sectional area smaller than those of the other spaces.

When the upper mold 14 is lowered to a predetermined position, the three-way valve 64 is closed, and the pump 66 is deactuated to stop the discharge. The timing at which the sealed room 58 is formed can be calculated from the lowering speed of the upper mold 14 and the positions of the first sealing member 32 and the second sealing member 56. The timing at which the discharge is stopped may be selected based on the calculated timing.

In the present embodiment, at this point in time, lowering of the upper mold 14 is temporarily stopped. Lowering of the upper mold 14 may be stopped at the same time, before, or after stopping of the discharge.

Then, a third step of the molding method is carried out. As shown in FIG. 4, a first predetermined amount of the liquid resin 76 is supplied from the injector 74. Preferred examples of the liquid resin 76 include reactive polyamide resins (ε-caprolactam resins), epoxy resins, and urethane resins. In the event that a reactive polyamide resin (ε-caprolactam resin) is used, a catalyst or an activator may be supplied simultaneously therewith. Examples of suitable catalysts include alkali metal such as sodium, alkaline-earth metal, and oxide, hydroxide, and hydride thereof. Examples of suitable activators include isocyanate, acyl-lactam, isocyanurate derivative, acid halide, and carbamide lactam.

In the event that an epoxy resin is used, a hardener may be supplied simultaneously therewith. Examples of suitable hardeners include acid anhydride, aliphatic polyamine, amide-amine, polyamide, Lewis base, and aromatic polyamine. In the case of using a urethane resin, a polyol, an isocyanate, and a third component may be supplied simultaneously therewith.

The liquid resin 76 moves through the runner 72 and is introduced into the first space 82 in the production cavity 16, more specifically, the space between the second flat wall 20 and the fifth flat wall 38. Then, the liquid resin 76 moves downward into the space between the first depression 22 and the second protrusion 40. Such downward movement is caused readily by the force of gravity, which acts on the liquid resin 76.

When the space between the first depression 22 and the second protrusion 40 is filled with the liquid resin 76, the liquid resin 76 overflows and is introduced into the space between the third flat wall 24 and the sixth flat wall 42. In this manner, the liquid resin 76 spreads into each portion in the first space 82. After the first predetermined amount of the liquid resin 76 has been introduced into the first space 82, injection of the liquid resin 76 from the injector 74 is stopped temporarily.

Before, after, or at the same time as when injection of the liquid resin 76 is stopped, the three-way valve 64 is operated in order to select the flow path that communicates with atmosphere. Thus, the open tube 68 becomes connected with the sealed room 58, so that the sealed room 58 is opened to atmosphere. Consequently, the internal pressure in the sealed room 58 increases to atmospheric pressure.

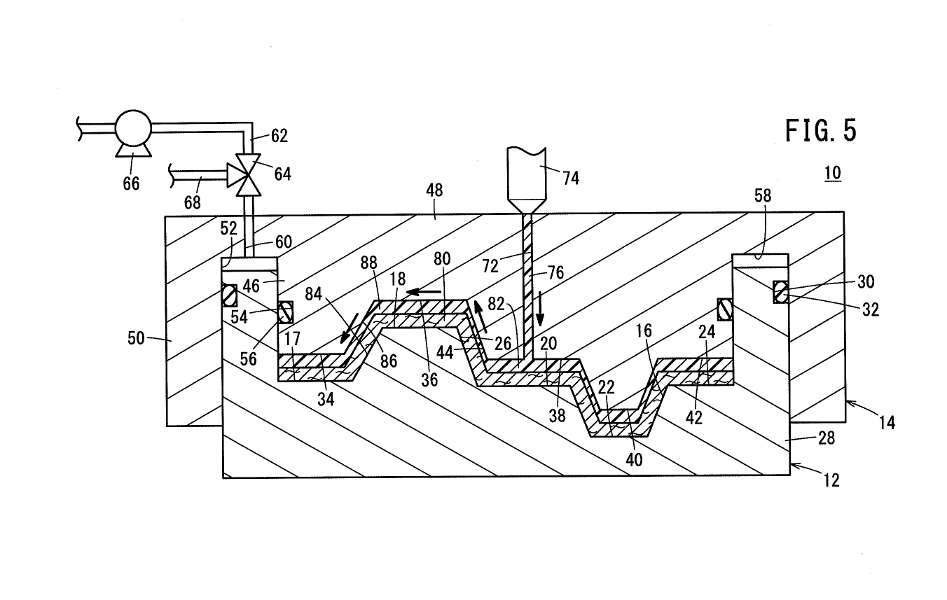

Then, the upper mold 14 is further lowered in order to initiate a fourth step of the molding method. Closing of the molds is restarted, so that the volume of the production cavity 16 is reduced, as shown in FIG. 5. Thus, the volumes of the first space 82 and the second space 88 are both reduced.

At the same time or after starting of the reduction in volume of the second space 88, or in other words, at the same time or after restarting of lowering of the upper mold 14, in a fifth step of the molding method, a second predetermined amount of the liquid resin 76 is supplied from the injector 74. The first and second predetermined amounts may be the same or different amounts. Reinjection of the liquid resin 76 may be carried out during or after closing of the molds. In the present description, the phrase “closing of the mold(s)” implies a process of closing the lower mold 12 and the upper mold 14 until a small gap, through which the liquid resin 76 can flow, is formed between the base fiber material 80 and the cavity forming surface of the upper mold 14. Thus, closing of the molds is completed or terminated upon formation of the small gap.

For example, in a case that reinjection is carried out during the mold closing process, as shown in FIG. 5, the first protrusion 18 is inserted into the second depression 36 during the mold closing process. Meanwhile, the second protrusion 40 is inserted into the first depression 22. Due to insertion thereof, the liquid resin 76 in the first space 82 is pressed. The pressed liquid resin 76 is expanded (spread) along the base fiber material 80. Since the liquid resin 76 is pressed by the second protrusion 40 (the upper mold 14) and the production cavity 16 is kept under negative pressure, the liquid resin 76 can be spread readily.

In the present embodiment, during the process of changing from the open state (see FIG. 1) to the closed state (see FIG. 5), the inner pressure of the enclosed space 70 containing the production cavity 16 is reduced to a negative pressure. Therefore, as the mold closing process proceeds, the liquid resin 76 in the first space 82, which is under negative pressure, is pressed by the upper mold 14. Thus, the liquid resin 76 can be spread sufficiently along the base fiber material 80.

A portion of the liquid resin 76 may flow through the space between the first inclined wall 26 and the second inclined wall 44 to the second space 88.

When the liquid resin 76 is further injected into the gap between the second flat wall 20 and the fifth flat wall 38 in the first space 82, the liquid resin 76 flows toward the clearance between the first inclined wall 26 and the second inclined wall 44 due to the fact that the first space 82 already is filled with the liquid resin 76. As described above, the narrow portion having a smaller cross-sectional area is formed between the first inclined wall 26 and the second inclined wall 44. Therefore, the liquid resin 76 flows under a high pressure in the narrow portion between the inclined walls.

Consequently, the liquid resin 76 flows toward the downstream second space 88. In the reinjection step, in the case that the cross-sectional area of the second space 88 and thus the distance between the lower mold 12 and the upper mold 14 are excessively small, the liquid resin 76 can hardly reach the end of the second space 88, and the volume ratio of the fiber is reduced at the edge of the molded FRP article 78. The distance between the lower mold 12 and the upper mold 14 is controlled in the reinjection step, in such a manner that the liquid resin 76 can reach the end of the second space 88 in order to avoid the aforementioned problem.

For these reasons, the liquid resin 76 can be spread throughout the space between the first flat wall 17 and the fourth flat wall 34, which is formed in the most downstream position (i.e., at the end) of the second space 88. Thus, the liquid resin 76 can be spread evenly over the base fiber material 80. Spreading of the liquid resin 76 is improved also due to the negative pressure in the production cavity 16.

Thus, the first predetermined amount of the liquid resin 76 is supplied to the first space 82 having a relatively large volume, and thereafter, the second predetermined amount of the liquid resin 76 is additionally supplied to the first space 82 and is transferred through the narrow portion (between the first inclined wall 26 and the second inclined wall 44). In this case, the liquid resin 76 can readily be spread and expanded to the downstream second space 88 having a relatively small volume. This is because the pressure that acts on the liquid resin 76 is increased in the narrow portion, as described above.

As described above, the liquid resin 76 flows from the upstream space between the second flat wall 20 and the fifth flat wall 38 in the first space 82, and through the downstream narrow portion to the further downstream second space 88. Therefore, the liquid resin 76 can be spread readily to the end of the second space 88. Thus, the molded FRP article 78 (shown in FIG. 6) can have a relatively large thickness or a relatively high fiber volume content.

The second sealing member 56 is located between the sealed room 58 and the production cavity 16. Therefore, even in the case that an excessive amount of the liquid resin 76 is supplied above the base fiber material 80, the liquid resin 76 can eventually be blocked by the second sealing member 56.

In the present embodiment, as described above, the inner pressure of the sealed room 58 is increased to atmospheric pressure while the production cavity 16 remains in a negative pressure state. Thus, the inner pressure of the sealed room 58 differs from and is higher than that of the production cavity 16. Therefore, even in the event that the liquid resin 76 cannot be blocked sufficiently due to a defect in the second sealing member 56, the liquid resin 76 is pressed by atmospheric air in the sealed room 58. Consequently, the liquid resin 76 can be prevented from being introduced into the sealed room 58.

As described above, according to the present embodiment, leakage of the liquid resin 76 to the outside from the production cavity 16 can be prevented. Therefore, the liquid resin 76 can be prevented from being introduced into the sealed room 58, the exhaust passage 60, the exhaust tube 62, or the three-way valve 64. Consequently, a reduction in the inspiratory force in a subsequent molding process can be prevented.

In addition, in the present embodiment, there is no need to take apart and clean the three-way valve 64 or to replace the three-way valve 64. Therefore, the molding method can be carried out repeatedly without interruption. Thus, molding can be performed more frequently per unit time, whereby molded FRP articles 78 can be produced with improved efficiency.

The spread liquid resin 76 permeates the fibers in the base fiber material 80. As shown in FIG. 6, the base fiber material 80 becomes impregnated with the liquid resin 76. Further, during this step, a so-called mold clamping process may be carried out in order to increase the pressing force of the upper mold 14.

Thereafter, at a predetermined time, the liquid resin 76 becomes hardened. Consequently, the molded FRP article 78 having a desired shape is produced. Thereafter, as shown in FIG. 7, the upper mold 14 is raised by the elevating mechanism, whereupon the molding apparatus 10 is returned to an open state. At this time, the molded FRP article 78 is released from the molding apparatus 10. Stated otherwise, a so-called demolding process (sixth step) is carried out. For example, during this step, an ejector pin (not shown) or the like may be used.

As described above, the liquid resin 76 is spread over the first space 82 and the second space 88 (the production cavity 16) while the liquid resin 76 is prevented from being drawn into the exhaust passage 60. Therefore, leakage of liquid resin 76 to the outside from the production cavity 16 can be prevented. Further, lack of the liquid resin 76 due to leakage can be prevented, and the occurrence of an unimpregnated area in the molded FRP article 78 can be avoided. Consequently, the molded FRP article 78 can exhibit satisfactory strength.

Thus, in the present embodiment, a molded FRP article 78 having a large thickness or a high fiber volume content can be produced efficiently with a satisfactory strength and high yield. In addition, production efficiency can be improved.

The present invention is not limited to the above embodiment. Various changes and modifications may be made to the embodiment without departing from the scope of the invention.

For example, in the fifth step, reinjection of the liquid resin 76 may be carried out at the same time or after closing of the molds is terminated. Also, in this case, the liquid resin 76 can readily be spread for the reasons mentioned above.

After the first predetermined amount of the liquid resin 76 has been supplied into the production cavity 16, and until the second predetermined amount of the liquid resin 76 starts to be supplied to the production cavity 16, the upper mold 14 may be lowered continuously toward the lower mold 12. In other words, the third and fourth steps may be carried out successively while the upper mold 14 is lowered toward the lower mold 12. In the above embodiment, the first predetermined amount of the liquid resin 76 is injected (supplied), supply of the liquid resin 76 is temporarily stopped, and thereafter, the second predetermined amount of the liquid resin 76 is injected (supplied). However, supply of the liquid resin 76 may continue to be carried out even after the first predetermined amount of the liquid resin 76 has been supplied, and the second predetermined amount of the liquid resin 76 may be supplied at a desired timing. In this case, the amount of the liquid resin 76, which is supplied after supply of the first predetermined amount and before supply of the second predetermined amount, may be smaller than the first and second predetermined amounts.

A two-way valve may be used instead of the three-way valve 64. In this case, the steps of supplying the liquid resin 76 and the subsequent steps thereafter may be carried out without opening the sealed room 58 to atmosphere.

In contrast to the aforementioned embodiment, the first sealing member 32 and the second sealing member 56 may be disposed respectively on the upper mold 14 and the lower mold 12. Alternatively, both the first sealing member 32 and the second sealing member 56 may be disposed on one of the lower mold 12 and the upper mold 14. In such cases as well, the above-described molding method using the molding apparatus 10 can be carried out.

What is claimed is:

1. A molding method for impregnating a base fiber material placed in a production cavity defined between a lower mold and an upper mold, with a liquid resin supplied to the production cavity, in order to produce a molded article of a fiber-reinforced plastic,
wherein:
a first sealing member and a second sealing member are disposed respectively on the lower mold and the upper mold, or both the first sealing member and the second sealing member are disposed on the lower mold or the upper mold; and
at least one of the lower mold and the upper mold has an exhaust passage; and
the method comprises:
a first step of, when the upper mold is moved relatively toward the lower mold, using the first sealing member to form an enclosed space containing the production cavity between the lower mold and the upper mold;
a second step of, after formation of the enclosed space, discharging a gas in the enclosed space from the exhaust passage;
a third step of, when the upper mold is moved relatively further toward the lower mold, using the second sealing member to divide the enclosed space into the production cavity and a sealed room, wherein the sealed room is formed between the first sealing member and the second sealing member and communicates with the exhaust passage, and thereafter supplying a first predetermined amount of the liquid resin to the production cavity;
a fourth step of, when the upper mold is moved relatively further toward the lower mold, reducing the volume of the production cavity;
a fifth step of, at same time or after a reduction in volume of the production cavity, supplying a second predetermined amount of the liquid resin to the production cavity and allowing the liquid resin to flow; and
a sixth step of hardening the liquid resin, with which the base fiber material has been impregnated, to thereby prepare the molded article, and thereafter releasing the molded article from the lower mold and the upper mold.

2. The molding method according to claim 1, wherein the third and fourth steps are carried out successively while the upper mold is moved relatively further toward the lower mold.

3. The molding method according to claim 1, wherein after the first predetermined amount of the liquid resin has been supplied and until the second predetermined amount of the liquid resin starts to be supplied, a smaller amount of the liquid resin is supplied continuously to the production cavity, the smaller amount being smaller than the first and second predetermined amounts.

4. The molding method according to claim 1, wherein in the fifth step, the second predetermined amount of the liquid resin is supplied to the production cavity at same time or after termination of closing of the molds.

5. The molding method according to claim 1, wherein:
the production cavity contains a first space and a second space;
the second space is connected to the first space and has a volume smaller than that of the first space;
after the enclosed space has been divided into the production cavity and the sealed room using the second sealing member, closing of the molds is temporarily stopped, and then the liquid resin is supplied to the first space; and
at same time or after the reduction in volume of the production cavity, the second predetermined amount of the liquid resin is supplied to the first space and is allowed to flow into the second space.

6. The molding method according to claim 5, wherein:
the lower mold has a flat wall and a rising wall that extends therefrom, the upper mold has an opposite flat wall facing the flat wall and an opposite rising wall that extends therefrom and faces the rising wall, and the first space contains a space formed by the flat wall, the rising wall, the opposite flat wall, and the opposite rising wall;
a distance between the rising wall and the opposite rising wall is smaller than a distance between the flat wall and the opposite flat wall;
the liquid resin flows from an upstream clearance between the flat wall and the opposite flat wall toward a downstream clearance between the rising wall and the opposite rising wall; and
the second space is formed on a downstream side of the downstream clearance between the rising wall and the opposite rising wall.

7. The molding method according to claim 5, wherein in the fifth step, the second predetermined amount of the liquid resin is supplied to the first space at same time or after termination of the closing of the molds.

8. A molding apparatus comprising a lower mold, an upper mold, an exhaust unit, and an injector, configured to impregnate a base fiber material placed in a production cavity defined between the lower mold and the upper mold, with a liquid resin supplied to the production cavity, in order to produce a molded article of a fiber-reinforced plastic,
wherein:
a first sealing member and a second sealing member are disposed respectively on the lower mold and the upper mold, or both the first sealing member and the second sealing member are disposed on the lower mold or the upper mold;
at least one of the lower mold and the upper mold has an exhaust passage;
when the upper mold is moved relatively toward the lower mold, the first sealing member is used to form an enclosed space containing the production cavity between the lower mold and the upper mold;
after formation of the enclosed space and when the upper mold is moved relatively further toward the lower mold, the second sealing member is used to divide the enclosed space into the production cavity and a sealed room, the sealed room being formed between the first sealing member and the second sealing member and communicating with the exhaust passage;
prior to formation of the sealed room, a gas in the enclosed space is discharged from the exhaust passage by the exhaust unit;
the liquid resin is supplied through the lower mold or the upper mold to the production cavity by the injector;
after a first predetermined amount of the liquid resin has been supplied to the production cavity and when the upper mold is moved relatively further toward the lower mold and a volume of the production cavity is reduced; and
at same time or after a reduction in volume of the production cavity, a second predetermined amount of the liquid resin is supplied to the production cavity by the injector.

9. The molding apparatus according to claim 8, wherein after the first predetermined amount of the liquid resin has been supplied to the production cavity and until the second predetermined amount of the liquid resin starts to be supplied to the production cavity, the upper mold is relatively moved continuously toward the lower mold.

10. The molding apparatus according to claim 8, wherein after the first predetermined amount of the liquid resin has been supplied to the production cavity and until the second predetermined amount of the liquid resin starts to be supplied to the production cavity, a smaller amount of the liquid resin is supplied continuously to the production cavity by the injector, the smaller amount being smaller than the first and second predetermined amounts.

11. The molding apparatus according to claim 8, wherein the second predetermined amount of the liquid resin is supplied to the production cavity by the injector at same time or after termination of closing of the molds.

12. The molding apparatus according to claim 8, wherein:
the production cavity contains a first space and a second space;
the second space is connected to the first space and has a volume smaller than that of the first space;
when closing of the molds is temporarily stopped, the liquid resin is supplied to the first space by the injector; and
thereafter, the second predetermined amount of the liquid resin is supplied to the first space by the injector at same time the closing of the molds is restarted and the reduction in volume of the second space is started, or at same time or after termination of the closing of the molds.

13. The molding apparatus according to claim 12, wherein:
the lower mold has a flat wall and a rising wall that extends therefrom, the upper mold has an opposite flat wall facing the flat wall and an opposite rising wall that extends therefrom and faces the rising wall, and the first space contains a space formed by the flat wall, the rising wall, the opposite flat wall, and the opposite rising wall;
a distance between the rising wall and the opposite rising wall is smaller than a distance between the flat wall and the opposite flat wall; and
the second predetermined amount of the liquid resin is supplied to the first space by the injector in such a manner that the liquid resin flows from an upstream clearance between the flat wall and the opposite flat wall and through a downstream clearance between the rising wall and the opposite rising wall toward the second space.

14. The molding apparatus according to claim 8, further comprising a sealed room opening unit, which is capable of opening the sealed room to atmosphere by way of the exhaust passage.

15. The molding apparatus according to claim 14, wherein the sealed room opening unit contains a three-way valve.
